(19) United States
(12) Patent Application Publication
(10) Pub. No.: US 2012/0215904 A1
(43) Pub. Date: Aug. 23, 2012

(54) Backup System Monitor

(75) Inventors: Anastasios Triantafillos, Addison, IL (US); Ankur Kumar, Hyderabad (IN)

(73) Assignee: BANK OF AMERICA CORPORATION, Charlotte, NC (US)

(21) Appl. No.: 13/031,689

(22) Filed: Feb. 22, 2011

(51) Int. Cl. G06F 15/173

(52) U.S. Cl. 709/224

(57) ABSTRACT

A system and method of monitoring and displaying a status of a backup at one or more locations is presented. The system and method may include identifying a status of a backup at a first location, identifying a status of a backup at a second location and displaying the statuses at a backup system monitor. In some examples, the statuses may be displayed simultaneously. In still other examples, the received status of a backup system may be flagged if it is within a predetermined threshold. The received statuses may be displayed graphically in order to aid in identifying issues and prioritizing allocation of resources.

### BACKGROUND

Security and preservation of data of computer networks, systems, servers, etc. is a top priority for most companies, government agencies, universities, etc. Accordingly, entities such as these generally have backup systems that backup various networks, servers, files, etc. that may be needed to recreate or restore the system in the event of a catastrophic failure. These backups may be performed on a periodic (daily, weekly, etc.) or aperiodic basis. In some examples, the backups may be performed on-demand. However, although the backups may be run on a regular basis, the success of the backup is critical to ensuring that data is preserved. Accordingly, users may review the status of a backup at each location individually in order to ensure that the backup was completed. This is time consuming and inefficient. Accordingly, it would be advantageous to provide a system to monitor the status of some or all of the systems being backed up and provide an overall view of the status of the backups as a whole.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a system and method of monitoring and displaying a status of a system backup at one or more locations is presented. The status of a first location may be received, for instance, at a backup system monitor. In some examples, if the status is within a predetermined threshold, the status may be flagged. If available, a status of a second location may be received at the backup system monitor. The status may be flagged if it is within a predetermined threshold. If any additional statuses are received, they may be flagged as well.

The received statuses may be displayed at the backup system monitor. For example, the statuses may be displayed simultaneously in order to view an overall status of the systems being backed up. The locations displayed may be selected and/or configured by a user or automatically based on specified rules and/or algorithms. In some arrangements, the statuses may be displayed graphically to provide additional indications of failures, warnings or other issues.

### BRIEF DESCRIPTION OF THE DRAWINGS

The present disclosure is illustrated by way of example and not limited in the accompanying figures in which like reference numerals indicate similar elements.

FIG. 1 illustrates an example operating environment in which various aspects of the disclosure may be implemented.

FIG. 2 illustrates an example system for monitoring the status of one or more backup systems and displaying that status according to one or more aspects described herein.

FIG. 3 illustrates one example method of receiving a status from one or more backup locations and displaying the received status(es) simultaneously for review according to one or more aspects described herein.

FIG. 4 illustrates one example user interface for displaying the received status from one or more locations according to one or more aspects described herein.

FIG. 5 illustrates another example user interface for configuring a display of the received status of one or more locations according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

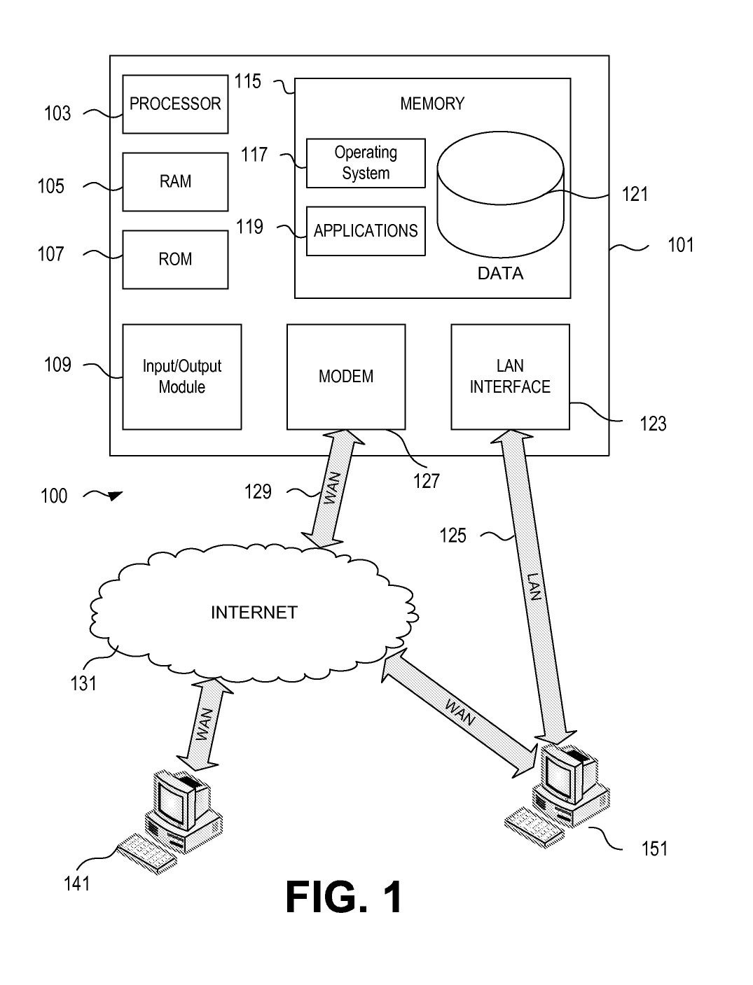

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses or corporate entities, such as financial institutions, as well as government organizations, universities, and other organizations having backup systems for one or more networks, servers, systems, etc. For instance, any entity having a backup system for one or more systems, networks, etc. may implement the backup monitor system described herein. In particular, entities having a regularly scheduled backup policy may realize additional advantages from the backup monitoring system described because the system displays the status of one or more backups. For instance, the system may display a most recent backup from all systems within the entity. In some examples, and as will be discussed more fully below, the status may be displayed on one screen or via a single monitoring interface such that the status of all systems, or selected systems, may be viewed, for instance, simultaneously. This allows a user to obtain an overall view or snapshot of the health or wellness of the systems being backed up.

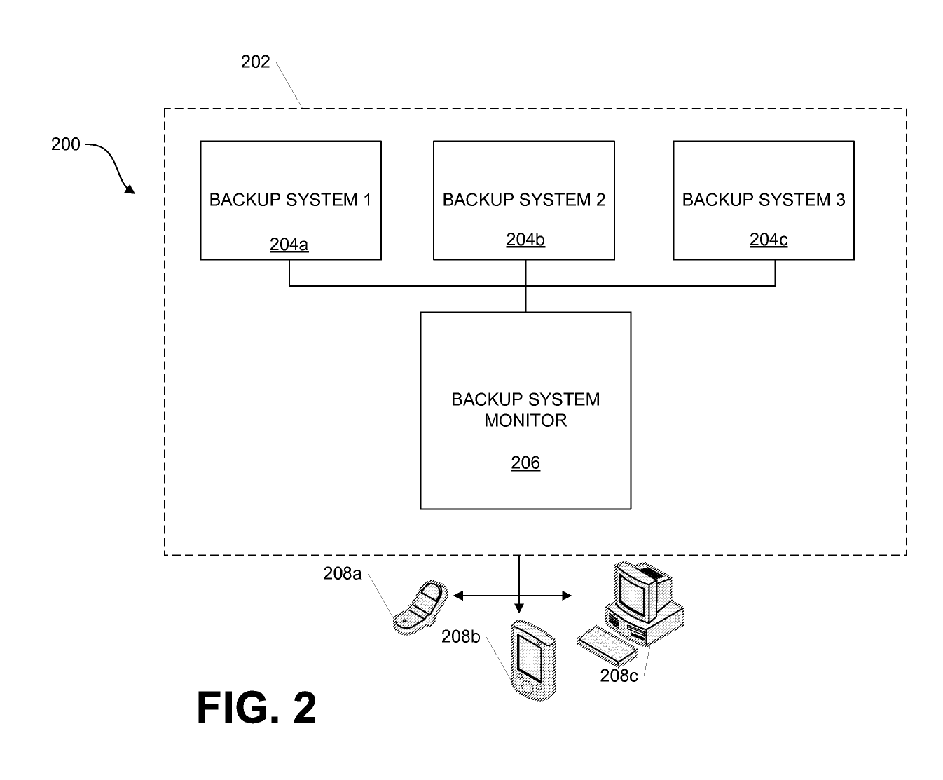

FIG. 2 illustrates one example system for monitoring the health and status of one or more backup systems. The system 200 may be contained within an entity 202 implementing the monitoring system. Additionally or alternatively, the monitoring system 200 may be external to or separate from the entity 202 having the systems being monitored. The system 200 may include one or more backup systems, such as backup systems 204a-204c. The backup systems 204a-204c may be backups of one or more networks, systems, etc. within the entity 202. The backup systems 204a-204c may be in various locations, such as different geographical locations. For example, if an entity has offices in Chicago, Ill., New York, N.Y. and Los Angeles, Calif., a backup system may be located in each office. Additionally or alternatively, separate networks, systems, servers, etc. in the same geographic location may have multiple backup systems. Accordingly, backup systems 204a-204c may be in the same or different geographic locations. Further, although three backup systems 204a-204c are shown in FIG. 2, more or fewer backup systems may be used with the system 200 described herein without departing from the invention.

The system may further include a backup system monitor 206. The backup system monitor may be located in one of the locations (such as geographic locations) of the backup systems 204a-204c or may be located remotely from the backup systems 204a-204c. In some examples, the backup system monitor 206 may be connected, such as via a network (e.g., Internet, intranet, etc.) to the backup systems 204a-204c. In some examples, the backup system monitor 206 may receive a status of a backup or plurality of backups performed at the backup systems 204a-204c. For instance, as each backup system 204a-204c performs a backup of its respective system, network, server, etc., the status of that backup may be transmitted to the backup system monitor 206. In some arrangements, the status may include whether the backup was successful, if there was an interruption in the backup, whether warnings or failures occurred, etc. The status of each backup system 204a-204c may be transmitted to the backup system monitor 206 in order to allow a user to review and/or monitor the status of some or all backup systems 204a-204c simultaneously.

For instance, a user may access the backup system monitor 206, such as via user devices including, for instance, a user cell phone or smart phone 208a, personal digital assistant 208b and/or computer 208c. The users may, as will be discussed more fully below, configure the display received from the backup system monitor 206 in order to display the status of any desired (possibly all available) backup systems. In some arrangements, the status may be displayed graphically in order to aid in identifying failures or other items needing action.

The simultaneous display of the status of all desired systems, and from one central site, may aid in identifying issues and taking action to correct those issues. For instance, if a user can evaluate the status of multiple systems simultaneously, he or she may more easily identify systems having a greater number of failures or warnings, as compared to other systems. This may help to prioritize which systems should receive resources (equipment, man power, etc.) to improve performance.

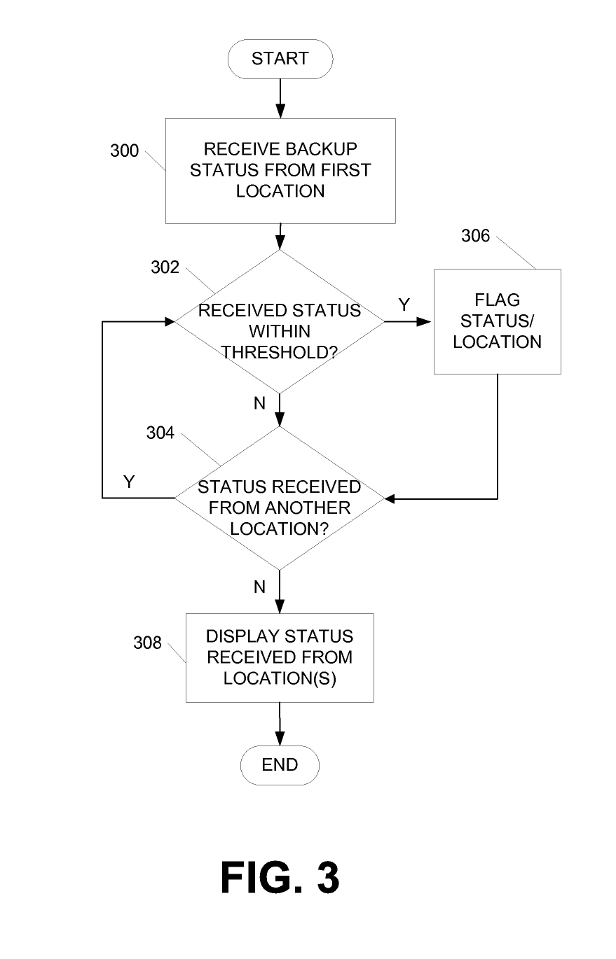

FIG. 3 illustrates one example method of receiving one or more backup statuses and displaying those statuses simultaneously for evaluation. In step 300, a backup status from a first location is received, for instance, at the backup system monitor (206 in FIG. 2). As discussed above, the first location may be a first geographic location or may be a first system location within a geographic location at which multiple backup systems exist. In step 302, a determination is made as to whether the received status is within a predetermined threshold. For instance, if the received status is below a predefined threshold for percent complete, percent successful, etc., the status may be flagged, as in step 306. In some examples, the predefined threshold may be determined by a user. In some arrangements, the status may include a visual identifier, such as a change of color on the backup system monitor display, to indicate that the value is outside the predefined threshold. In some examples, the status received may have a desired success rate between 90% and 100%. If the success rate falls outside of that range, the status may be flagged, as in step 306. In some examples, the desired success rate may be 95% to 98% and any status falling outside of that range may be flagged.

In addition, one or more particular warnings or failures may cause the status to be flagged. For instance, if backup of a particular file or files was not completed, a warning may be issued, causing the status to be flagged. In some arrangements, the backup system monitor may identify the file or files not backed up and may transmit an indication that the file or files were not backed up.

If the status is not within a predefined threshold in step 302, a determination is made in step 304 as to whether a status from an additional backup system at another location as been received. For instance, the system may determine whether a status was received from a backup system at another geographic location different from the first location or from another system at the same geographic location as the first system. If an additional status has been received in step 304, a determination will be made in step 302 as to whether the received status is within the predetermined threshold. If so, the status/location will be flagged in step 306. If the status is not within the predetermined threshold, the system will again determine whether a status from another location has been received in step 304. If no additional statuses have been received, the received statuses, and any determined flags, etc., may be displayed in step 308.

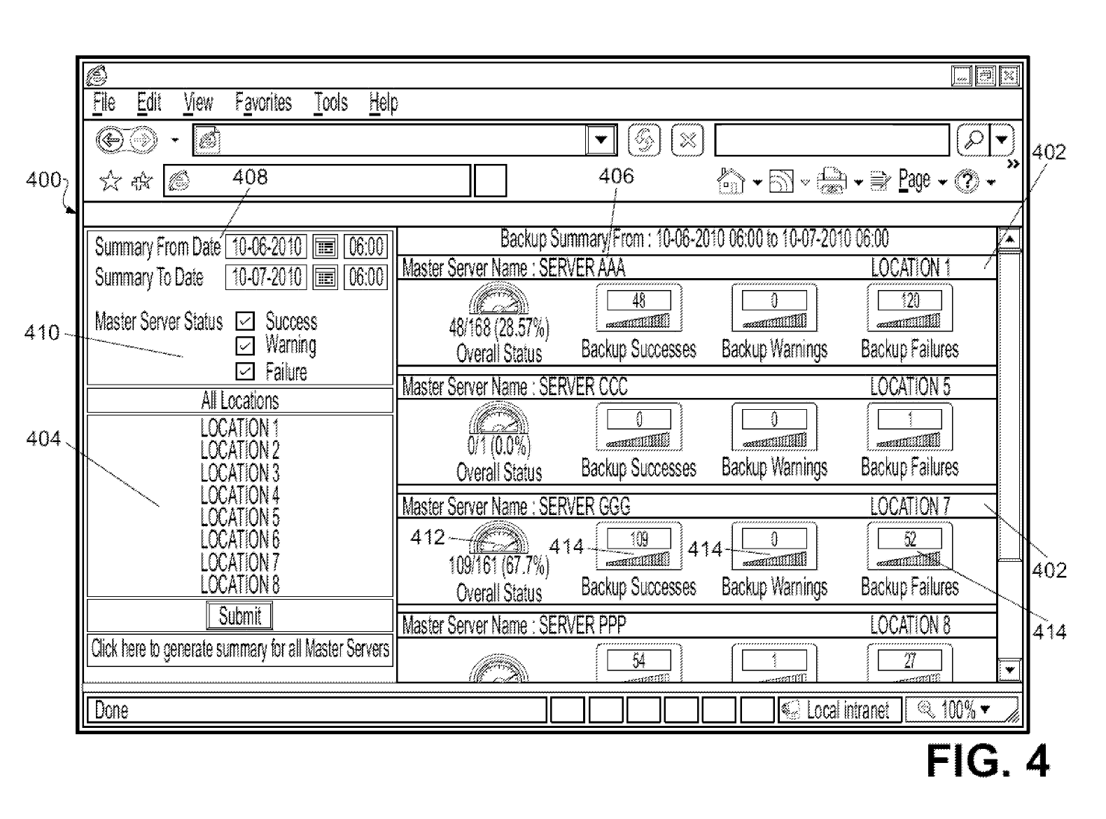

FIG. 4 illustrates one example display that may be provided by the backup system monitor. The display 400 may include one or more locations 402 being monitored by the backup system monitor. In some examples, the locations 402 displayed may be selected from a location selection field 404. The location selection field 404 may include some or all available locations that may be displayed. In addition, each location may include a server name 406 identifying the server at that location being displayed.

The display may also include a date range field 408. A user may select a desired date range for which the status of the selected locations may be displayed. For instance, if a user desires to view the status of one or more locations for the week, they can select an appropriate date range in field 408. In some examples, another date range field (not shown) may include predefined time periods, such as previous day, previous week, previous month, etc. The desired predefined range may be selected, for instance, from a drop-down menu.

The display may further include status flag or display options 410. By selecting or deselecting one or more of the options provided in field 410, the user may customize the status warnings displayed. For instance, if a user desires to see only systems having warnings or failures, the user may deselect the “success” option and select “warnings” and “failures.” In addition, the options provided in field 410 may be color coded to correspond to the appearance of those statuses in the display.

Display 400 may further include one or more graphical depictions of the status of the identified server at the identified location. For instance, a gauge 412 may be provided to illustrate the overall status of the identified server at the identified location. The gauge 412 may graphically depict the overall status using a needle to indicate a point along the scale corresponding to the percentage of successful backups for that server. Further, the gauge scale may be color coded to provide an additional visual indication of the overall status. For instance, if the needle points to a region colored red, several failures may have occurred. If the needle points to the region colored green, the backups may have had a high success rate. Further, if the needle points to the region colored yellow, several warnings may have occurred or been issued. Although a color coded gauge is shown in FIG. 4, various other graphical representations of the success of the backup may be used without departing from the invention.

In some arrangements, the display 400 may include additional gauges 414, providing more specific information about successes, failures and warnings. For instance, each server displayed may have a gauge 414 providing the number of successes, failures and warnings, and, in some instances, providing a graphical depiction of those values. The graphical depiction may include a color coded scale similar to the one described above. In some arrangements, a user may click on one or more of the graphics provided in display 400 and may receive more information about the status. For instance, upon clicking on gauge 412, a pop-up window (not shown) may appear and provide additional information about the overall status. In some examples, the additional information may include the number of files successfully backed up, the number of failures, the number of warnings, status codes, etc. In some arrangements, the additional information may include identifying a particular file that was skipped or failed to successfully backup. In still other arrangements, a user may be prompted to attempt to backup the file identified as skipped or unsuccessful or, in some examples, another attempt may automatically be made.

The display 400 provides a user monitoring the backup of various systems with a broad, overall view of the backup environment. That is, the user may monitor several or all backup locations simultaneously in order to identify areas with issues. This aids in prioritizing allocation of resources, such as manpower, equipment, etc. for the backup systems.

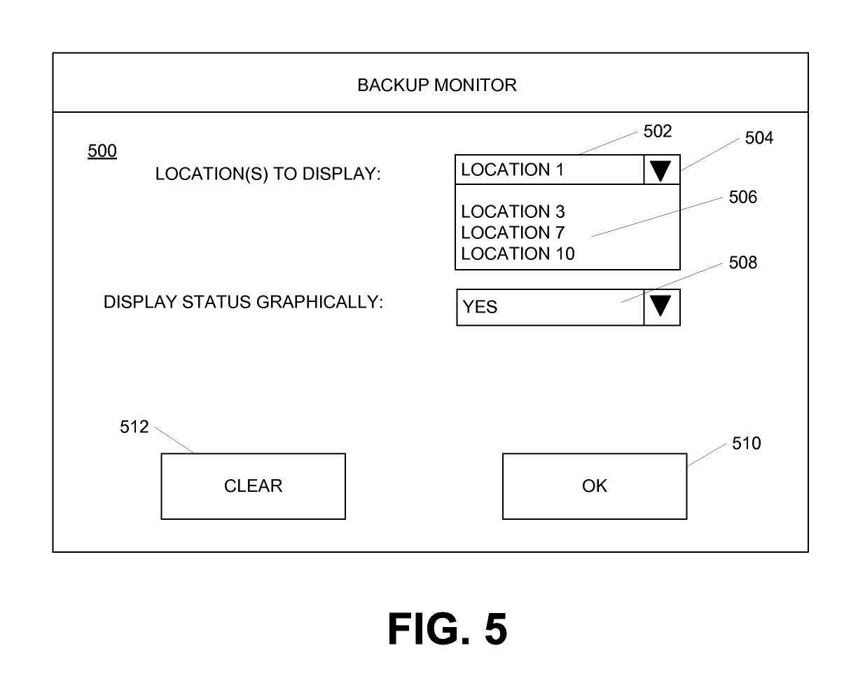

FIG. 5 illustrates one example user interface 500 for configuring a backup system monitor display, such as display 400 in FIG. 4. In field 502, a user may identify one or more locations to be displayed. For example, a user may insert the name of one or more locations (e.g., separated by commas, semicolons, etc.) or may click drop-down arrow 504 to display a list of available locations 506. The user may select one or more locations from the list (such as by holding Ctrl while selecting multiple locations). The interface may also include field 508 in which a user can select whether to display the status of the location graphically (as discussed above with respect to FIG. 4) or not. Once the desired selections have been made, the user may select “ok” option 510 in order to display the desired locations. Alternatively, the user may clear all entries by selecting “clear” option 512.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method, comprising:
identifying, by a backup monitoring system, a status of a first system backup performed at a first backup location;
identifying, by the backup monitoring system, a status of a second system backup performed at a second backup location, the second backup location being remote from the first backup location; and
displaying, at a monitoring location of the backup monitoring system, the identified status of the first system backup and the second system backup, wherein the monitoring location is located remotely from at least one of the first backup location and the second backup location.

2. The method of claim 1, wherein the monitoring location is located remotely from both the first backup location and the second backup location.

3. The method of claim 1, wherein the identified status of the first system backup and the second system backup are displayed graphically.

4. The method of claim 1, further including:
identifying, by the backup monitoring system, a status of a third system backup performed at a third backup location; and
displaying, at the monitoring location, the identified status of the third system backup with the identified status of the first system backup and the second system backup.

5. The method of claim 4, wherein the monitoring location is located remotely from the first backup location, the second backup location and the third backup location.

6. A method, comprising:
receiving, by a backup monitoring system, a status of a backup at a first backup system at a first backup system location;
identifying, by the backup monitoring system, whether the received status of the first backup system is within a predetermined threshold;
responsive to determining that the received backup status is within the predetermined threshold, flagging the status;
determining whether a status has been received from a second backup system at a second backup system location located remotely from the first backup system location;
responsive to determining that a status has been received from the second backup system, identifying, by the backup monitoring system, whether the received status of the second backup system is within the predetermined threshold; and
displaying, at a monitoring location of the backup monitoring system, the status of the first backup system and the second backup system.

7. The method of claim 6, wherein the status of the first backup system and the second backup system are displayed simultaneously.

8. The method of claim 7, wherein the status of the first backup system and the second backup system are displayed graphically.

9. The method of claim 6, wherein the monitoring location is located remotely from at least one of the first backup system location and the second backup system location.

10. The method of claim 6, wherein the monitoring location is located remotely from both the first backup system location and the second backup system location.

11. The method of claim 6, further including:
responsive to determining that a status has not been received from the second backup system, displaying, at the monitoring location of the backup monitoring system, the status of the first backup system.

12. One or more non-transitory computer readable media storing computer readable instructions that, when executed, cause an apparatus to:
receive, by a backup monitoring system, a status of a backup at a first backup system at a first backup system location;
identify, by the backup monitoring system, whether the received status of the first backup system is within a predetermined threshold;
responsive to determining that the received backup status is within the predetermined threshold, flag the status;
determine whether a status has been received from a second backup system at a second backup system location located remotely from the first backup system location;
responsive to determining that a status has been received from the second backup system, identify, by the backup monitoring system, whether the received status of the second backup system is within the predetermined threshold; and
display, at a monitoring location of the backup monitoring system, the status of the first backup system and the second backup system.

13. The one or more non-transitory computer readable media of claim 12, wherein the status of the first backup system and the second backup system are displayed simultaneously.

14. The one or more non-transitory computer readable media of claim 13, wherein the status of the first backup system and the second backup system are displayed graphically.

15. The one or more non-transitory computer readable media of claim 12, wherein the monitoring location is located remotely from at least one of the first backup system location and the second backup system location.

16. The one or more non-transitory computer readable media of claim 12, wherein the monitoring location is located remotely from both the first backup system location and the second backup system location.

17. The one or more non-transitory computer readable media of claim 12, wherein the instructions, when executed, further cause the apparatus to:
responsive to determining that a status has not been received from the second backup system, display, at the monitoring location of the backup monitoring system, the status of the first backup system.

18. An apparatus, comprising:
at least one processor; and
memory operatively coupled to the processor and storing computer readable instructions that, when executed, cause the apparatus to:
receive, by a backup monitoring system, a status of a backup at a first backup system at a first backup system location;
identify, by the backup monitoring system, whether the received status of the first backup system is within a predetermined threshold;
responsive to determining that the received backup status is within the predetermined threshold, flag the status;
determine whether a status has been received from a second backup system at a second backup system location located remotely from the first backup system location;
responsive to determining that a status has been received from the second backup system, identify, by the backup monitoring system, whether the received status of the second backup system is within the predetermined threshold; and
display, at a monitoring location of the backup monitoring system, the status of the first backup system and the second backup system.

19. The apparatus of claim 18, wherein the status of the first backup system and the second backup system are displayed simultaneously.

20. The apparatus of claim 19, wherein the status of the first backup system and the second backup system are displayed graphically.

21. The apparatus of claim 18, wherein the monitoring location is located remotely from at least one of the first backup system location and the second backup system location.

22. The apparatus of claim 18, wherein the monitoring location is located remotely from both the first backup system location and the second backup system location.
